(19) United States
(12) Patent Application Publication
(10) Pub. No.: US 2007/0263507 A1
(43) Pub. Date: Nov. 15, 2007

(54) Optical disc apparatus and method of determining writing power of the same

(75) Inventors: Ji Seon Baek, Suwon-si (KR); Otsuka Tatsuhiro, Suwon-si (KR); Jin Woo Yu, Suwon-si (KR); Young Jae Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/706,954

(22) Filed: Feb. 16, 2007

(30) Foreign Application Priority Data
May 12, 2006 (KR) 2006-43090

(51) Int. Cl. G11B 5/00

(52) U.S. Cl. 369/47.53

(57) ABSTRACT

An optical disc apparatus and a method of determining an optimal writing power are provided to reduce the time required for Optimum Power Calibration (OPC) and reduce the difference between OPC results. The optical disc apparatus includes a light source which emits a laser beam to write/read data to/from an optical disc; a reader which receives a laser beam reflected from the optical disc and reads data written on the optical disc; and a controller which, to reduce the difference between OPC results, controls the light source to write test data more than once for determining an optimal writing power, controls the reader to read the test data, measures read quality of the test data, and detects an optimal writing power based on the measured read quality.

### CROSS-REFERENCE TO RELATED APPLICATIONS

This application claims all benefits accruing under 35 U.S.C. §119 from Korean Patent Application No. 2006-43090, filed May 12, 2006 in the Korean Intellectual Property Office, the disclosure of which is incorporated herein by reference.

### BACKGROUND OF THE INVENTION

1. Field of the Invention

The present invention relates to an optical disc apparatus, and more particularly, to an optical disc apparatus and a method of determining an optimal writing power of the same, which can reduce time required for optimum power calibration (OPC) and also reduce the difference between OPC results.

2. Related Art

Recording media such as optical discs have been developed and commercialized to record and store image data and sound data with improved performance for a long period of time. Such optical disks can be classified as either compact disks (CDs) or digital versatile disks (DVD) according to data recording capacity. Examples of optical disks that can be recorded, deleted, and reproduced include 650 MB CD-Rs, CD-rewritables (RWs), 4.7 GB DVD+R/RWs, DVD-random access memories (RAMs), and DVD-R/RWs. Examples of optical disks that are dedicated for data reproduction include 650 MB CDs and 4.7 GB DVD-read only memories (ROMs). In addition, due to limitations in increasing storage capacity of the conventional DVD-ROM, standardization for new high-density optical discs, for example, rewritable blue-ray (BD) disc, has been rapidly advanced.

Generally, before data is written to an optical disc, an optimum power calibration (OPC) process is performed to determine an optimal writing power for recording data onto an associated optical disc, i.e., the best recording laser power setting for each optical disc and an optical disc (recording/reproducing) apparatus combination.

Typically, such an OPC process is performed in the following manner. Test data is written to an optical disc, while writing power is changed in multiple steps at a predetermined interval, and the written test data is read and then quality of the read signal is determined based on a jitter value or asymmetry of the read signal.

OPC is typically performed on a power calibration area (PCA) defined on an optical disc. The time to perform an OPC process slightly varies from one recording medium to another. For example, when a rewritable disc is inserted, an OPC process is performed after reading unique information of the inserted disc.

FIG. 1 is a flow chart of a conventional method of performing OPC. When an optical disc is inserted into an optical disc apparatus, an optical pickup is moved to a test area of the optical disc to perform an OPC process after reading unique information of the inserted disc such as its manufacturing company and disc type at operation S100. After the optical pickup is moved to the test area, test data having a specific pattern is written to the test area while changing writing power at a predetermined interval at operation S101. The writing power is typically changed in 10-15 steps at a predetermined interval from a start power that was experimentally set for each optical disc type. When writing the test data is completed, a position where the test data writing was started is sought to read the written test data so as to determine whether the writing quality of each writing power is high or low at operation S102. After the optical pickup is moved to the writing start position, the test data which has been written with writing powers changed in multiple steps is read and the quality of the read signal is measured and then the measured read quality of each writing power is stored at operation S103. The read signal quality is represented by a jitter value or an asymmetry value of a corresponding RF signal and, based on this value, whether the writing quality is high or low is determined at operation S103. To increase the reliability of such a determination, the measurement and storage of the read signal quality is repeated a predetermined number of times (n times) at operation S104. When the measurement and storage has been performed the predetermined number of times (n times), the optimal writing power for the inserted disc is detected and stored based on the stored measurements at operation S105.

Such a conventional OPC process is described in Korean Patent Application Publication No. 2000-20508.

In such a conventional process, OPC is performed to detect the optimal writing power using test data that has been written once. However, this results in a large difference between OPC results. The large difference between the OPC results makes it difficult to detect a reliable optimal writing power. In contrast, if OPC is performed using test data that has been written a number of times in order to reduce the difference between the OPC results, a significant amount of time is necessary to complete the OPC.

### SUMMARY OF THE INVENTION

Several aspects and example embodiments of the present invention provide an optical disc apparatus and a method of determining an optimal writing power of the same, which can more accurately detect the optimal writing power while reducing the time required for an optimum power calibration (OPC) process.

Additional aspects and/or advantages of the invention will be set forth in part in the description which follows and, in part, will be obvious from the description, or may be learned by practice of the invention.

In accordance with an embodiment of the present invention, there is provided an optical disc apparatus comprising a light source to emit a laser beam to write/read data to/from an optical disc; a reader to receive a laser beam reflected from the optical disc and read data written on the optical disc; and a controller to control the light source to write test data more than once for determining an optimal writing power, to control the reader to read the test data, to measure read quality of the test data, and to detect an optimal writing power based on the measured read quality.

According to an aspect of the present invention, the test data is written more than once on an optical disc, such that test data elements are consecutively written on a specific area of the optical disc without reading the written test data until writing the last test data element is completed.

According to an aspect of the present invention, the test data is read from an optical disc, such that the test data elements are sequentially read, starting from the first written test data element and ending with the last written test data element, after writing the test data is completed.

According to an aspect of the present invention, the optical disc apparatus is further provided with a storage to store a variety of data, in which the test data is read more than once and read quality of each of the test data elements is measured and the measured read quality of each of the test data elements is stored in the storage.

According to an aspect of the present invention, the test data is written on an optical disc while changing writing power applied to the light source. Such an optical disc is a write-once optical disc.

In accordance with another embodiment of the present invention, there is provided an optical disc apparatus comprising a light source to emit a laser beam to write/read data to/from an optical disc; a reader to receive a laser beam reflected from the optical disc and read data written on the optical disc; and a controller to control the light source to write test data more than once while changing positions where the test data is written for determining an optimal writing power for applying to the light source and thereafter to control the reader to read the test data, to measure read quality of the test data, and to detect an optimal writing power based on the measured read quality.

According to an aspect of the present invention, the test data is written more than once on an optical disc, such that test data elements are consecutively written on a specific area of the optical disc without reading the written test data until writing the last test data element is completed.

According to an aspect of the present invention, the test data is read from an optical disc such that test data elements are sequentially read, starting from the first written test data element and ending with the last written test data element, after writing the test data is completed. Such an optical disc is a write-once optical disc.

In accordance with yet another embodiment of the present invention, there is provided a method of determining a writing power of an optical disc apparatus to write/read data to/from an optical disc. Such a method comprises writing test data on a specific area of an optical disc more than once to determine an optimal writing power; reading the written test data more than once and measuring read quality of the test data; and determining an optimal writing power using the measured read quality.

According to an aspect of the present invention, writing the test data more than once on an optical disc comprises consecutively writing test data elements on a specific area of the optical disc without reading the written test data until writing the last test data element is completed.

According to an aspect of the present invention, reading the test data from an optical disc comprises sequentially reading the test data elements, starting from the first written test data element and ending with the last written test data element, after writing the test data is completed.

According to an aspect of the present invention, the test data elements are sequentially read from an optical disc, and read quality of each of the test data elements is measured and then the measured read quality of each of the test data elements is stored.

According to an aspect of the present invention, writing the test data comprises writing the test data on an optical disc, while changing writing power applied to the light source.

In accordance with yet another embodiment of the present invention, an optical disc apparatus is provided with an optical pickup to irradiate a laser beam onto an optical disc for recording and reproducing data; a memory having a designated area to store test data to perform optimum power calibration (OPC); a controller arranged to control the optical pickup and to access the memory for performing optimum power calibration (OPC), wherein the controller is configured to write test data on the designated area of the optical disc and repeat writing written test data at different segments within the designated area of the optical disc a predetermined number of times; read written test data at each segment of the designated area of the optical disc sequentially, while measuring the quality of a read signal representing the written test data at each segment within the designated area of the optical disc and storing measured results in the memory; and determine an optimal writing power based on the measured results and store the optical writing power in the memory for performing optimum power calibration (OPC).

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a flow chart of a conventional method of performing an optimum power calibration (OPC);

FIG. 2 is a block diagram of an optical disc apparatus according to an embodiment of the present invention;

FIG. 3 illustrates an optical disc including a test area where OPC is performed according to an embodiment of the present invention;

FIG. 4 is a flow chart of how an optimal writing power is detected according to a writing power determination method according to an embodiment of the present invention;

FIG. 5A is a detailed control flow diagram when writing power is detected after a plurality of test data is written according to a conventional OPC method; and

FIG. 5B is a detailed control flow diagram when writing power is detected according to a writing power determination method according to an embodiment of the present invention.

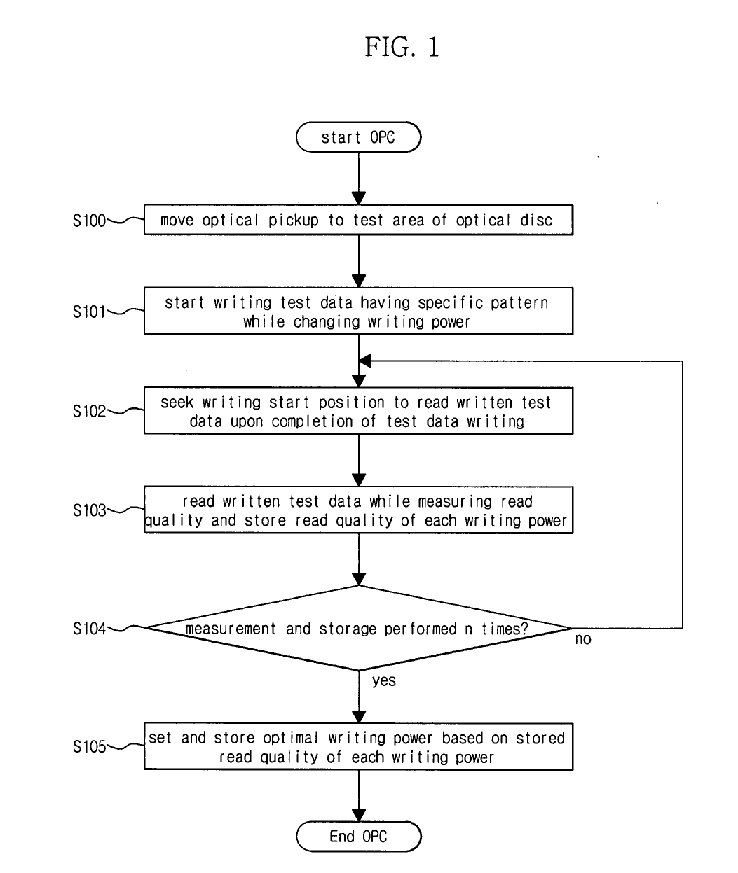

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

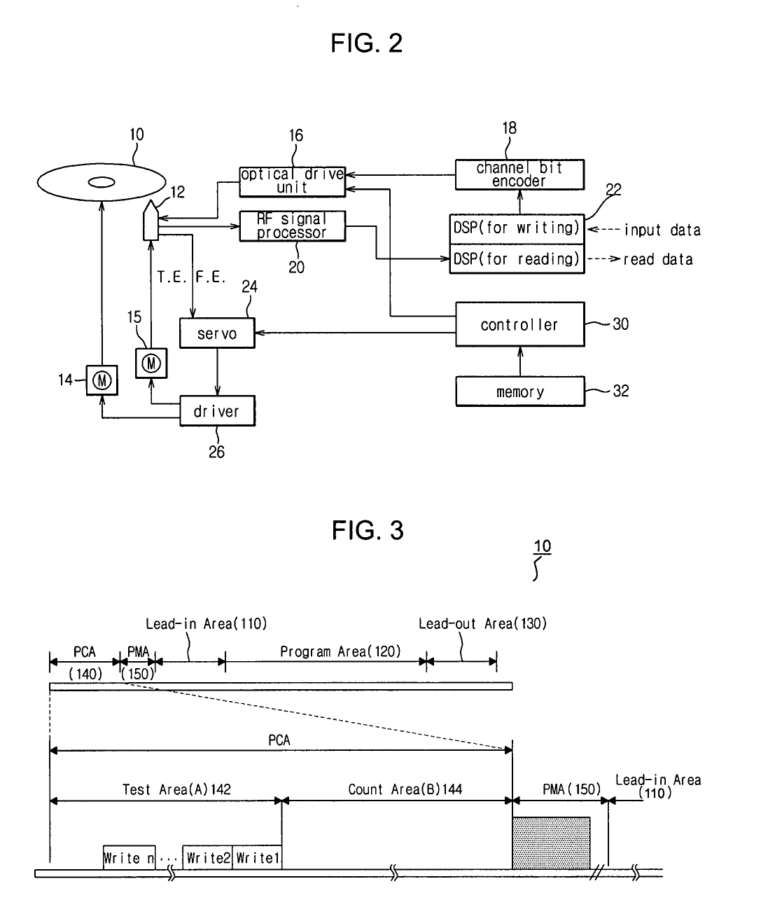

FIG. 2 is a block diagram of an optical disc apparatus according to an embodiment of the present invention. As shown in FIG. 2, the optical disc apparatus comprises an optical pickup 12, a spindle motor 14, a sled motor 15, an optical drive unit 16, a channel bit encoder 18, an RF signal processor 20, a digital signal processor (DSP) 22, a servo 24, a driver 24, a controller 30 and a memory 32. The driver 26 is arranged to drive the sled motor 15 and the spindle motor 14. The servo 24 is arranged to control operations of the driver 26. The controller 30 is configured to control overall operations of the optical disc apparatus and to control writing operations including an OPC operation, and the memory 32 is arranged to store a variety of data. For purposes of brevity, the optical disc apparatus, albeit in whole or in part, can also be referred to as a drive system which can be internal (housed within a host) or external (housed in a separate box that connects to a host (not shown)). The optical disc can be any high-density medium, such as blue-ray disc (BD) and advanced optical disc (AOD); however, other optical discs can also be utilized, including DVD, DVD-R, DVD-RW, DVD+RW, DVD-RAM, DVD-ROM, CD, CD-R, CD-RW, and CD-ROM. In addition, such an optical disc apparatus may be a single apparatus, or may be separated into a recording apparatus (i.e., digital video disc recorder “DVDR”) and a reading apparatus (i.e., compact disc player “CDP” or digital video disc player “DVDP”).

The DSP 22 includes a digital writing signal processor (DSP for writing) and a digital reading signal processor (DSP for reading). The digital writing signal processor converts input data, which has been MPEG-coded by an MPEG encoder, into a write format by adding an error correction code (ECC) or the like to the input data. The digital reading signal processor (DSP for reading) reconstructs a signal, which has been wave-shaped by the RF signal processor 20, into original data based on a signal synchronized with an output signal of the RF signal processor 20.

The channel bit encoder 18 inputs a bitstream which has been converted into the write format by the digital writing signal processor (DSP for writing), as a pulse width modulated (PWM) signal for writing on an optical disc 10, to the optical drive unit 16.

The optical drive unit 16 outputs a drive luminance signal corresponding to the input PWM signal to a laser diode (LD) that is a light source included in the optical pickup 12. The optical pickup 12 writes data on the optical disc 10 according to the drive luminance signal. Alternatively, the optical pickup 12 emits a laser beam with a read power according to the drive luminance signal and receives a laser beam reflected from a recording layer of the optical disc 10 and then outputs a read signal corresponding to the received beam to the RF signal processor 20.

The RF signal processor 20 converts a signal output from the optical pickup 12 into a wave-shaped signal. Using a tracking error signal (TE) and a focusing error signal (FE), the servo 24 outputs a control signal to the driver 26 to control the operation of the sled motor 15 to accurately follow the track of the optical disc 10.

The controller 30 controls overall operations of the optical disc apparatus including the optical drive unit 16 and the servo 24. When a new disc is inserted, the controller 30 controls a variety of test operations during a lead-in time of the optical disc. The term “lead-in time” generally refers to the time during which data on a specific area of the optical disc 10 is read to store unique information of the optical disc 10 in the memory 32 and various test operations including OPC are performed. If the inserted optical disc 10 is a write-once optical disc, OPC is generally performed to obtain the optimal writing power for the optical disc 10 when a command to write data on the inserted optical disc is input.

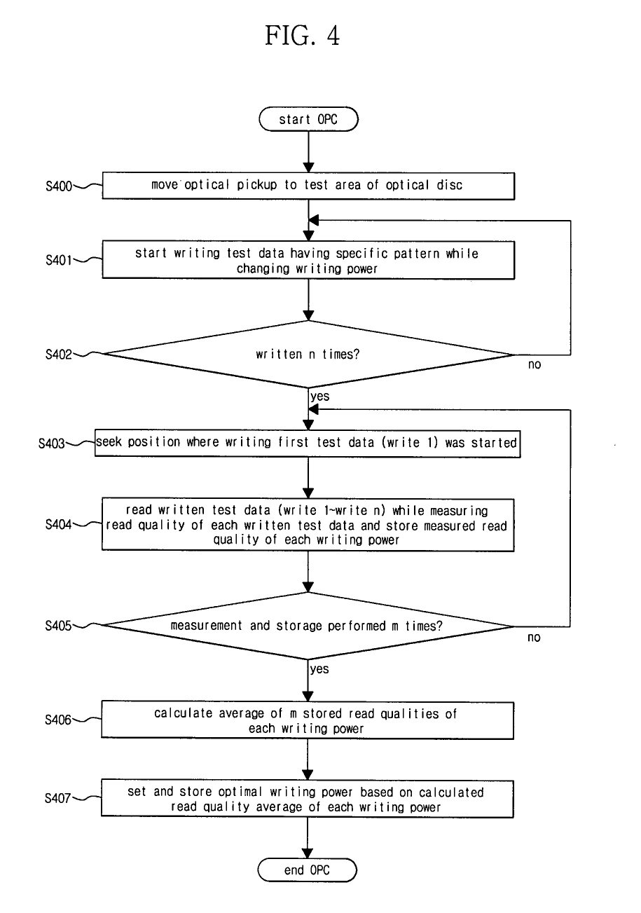

As shown in FIG. 3, the optical disc 10 includes a program (user data) area 120 where data is written, and lead-in and lead-out areas 110 and 130 that define the program (user data) area 120. The optical disc 10 also includes a power calibration area (PCA) 140, which is a test area where test data is written and read when performing OPC, and a program memory area (PMA) 150 where temporary data is written. The power calibration area (PCA) 140 and/or the program memory area (PMA) 150 may be separated or included in the lead-in area 110 on the optical disc 10.

To perform OPC, the controller 30 controls the optical pickup 12 to move the optical pickup 12 to the power calibration area (PCA) 140, as shown, for example, in FIG. 3, which is a test area defined on the optical disc 10, and controls the optical drive unit 16 to change the writing power at a predetermined interval when writing test data. When the test data writing is completed, the controller 30 seeks a position where the test data writing was started and moves the optical pickup 12 to the position. Then, the controller 30 reads the written test data and detects the optimal writing power using characteristics of the read signal.

In the conventional writing power determination method, an OPC process is performed a number of times and the optimal writing power is set using the OPC results. This OPC process is performed in such a manner that test data having a specific pattern is written once and the written test data is read a number of times and then the writing power is detected using the characteristics (or quality) of the read signal. Various methods may be used to set the optimal writing power. In one example, the average of the values of a number of OPC results is set as the optimal writing power. However, the result values of OPC that has been performed using the test data written once may have a large difference between OPC results due to the characteristics of the optical disc or external noise. This difference reduces the reliability of the set optimal writing power, making it difficult to accurately detect the writing power.

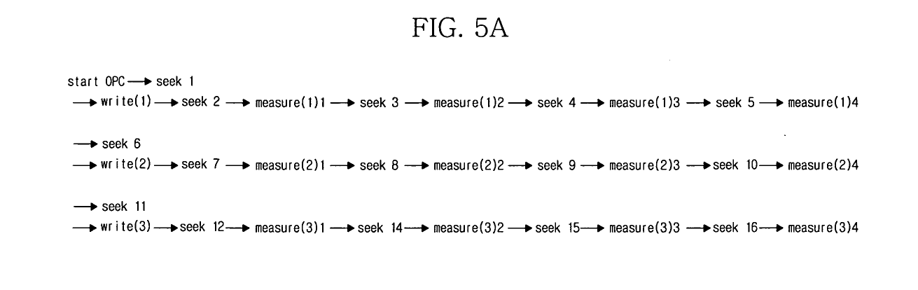

A method of determining an optimum writing power to efficiently reduce the difference between OPC results according to the present invention will now be described with reference to FIG. 4.

When OPC is started, the optical pickup 12, as shown in FIG. 2, is moved to a power calibration area (PCA) 140, that is, a test area of an optical disc 10, as shown, for example, in FIG. 3 at operation S400. When the optical pickup 12 is moved to the PCA 140, test data having a specific pattern is written on the PCA 140 while changing writing power at operation S401. This test data writing is repeated a predetermined number of times (i.e., n times) to reduce the difference between OPC results at operation S402. In this case, test data with different patterns may be written as needed. The test data written the predetermined number of times (i.e., n times) is denoted by “write 1” to “write n” shown in FIG. 3. In principle, n test data elements are consecutively written as shown in FIG. 3. However, if the test data is written starting from the end of the PCA 140, n test data elements may not be consecutively written. In this case, n test data elements are not consecutively written in the PCA 140, i.e., a test area of an optical disc 10. When the test data writing has been repeated n times at operation S402, a position where writing of the first test data “write 1” was started is sought and the optical pickup 12 is moved to that position in order to read the written test data at operation S403.

After the optical pickup 12 is moved to the start position, the test data elements, “write 1” to “write n”, are sequentially read and the quality of the read signal of each of the test data elements is measured and stored in the memory 32, as shown in FIG. 2. When the reading is completed once, a first measurement result of each of the test data elements, “write 1” to “write n”, is stored in the memory 32 at operation S404. When the reading has been performed a predetermined number of times (i.e., m times), m measurement results of each of the test data elements “write 1” to “write n” are stored in the memory 32 at operation S405. The controller 30 detects the optimal writing power using the m measurement results of each of the test data elements “write 1” to “write n” stored in the memory 32.

For example, the controller 30 calculates the average of the m measurement results, and determines an optimal writing power based on the calculated average and then stores the determined optimal writing power in the memory 32 (at operation S406 and operation S407).

As previously discussed, when the conventional OPC method is utilized to reduce the difference between OPC results, the time required to perform OPC is increased, thereby increasing the lead-in time during which unique information of an inserted optical disc 10 is read and stored in the memory 32, as shown in FIG. 2, and various test operations including OPC are performed. This problem is more serious for a recordable optical disc, such as a CD-R and a DVD-R for which OPC is performed when a write command is input. In the case of a write-once recording medium, data to be written is temporarily stored in a buffer, while OPC is performed after a write command is input and writing the data is started after the OPC is completed. Thus, the required buffer capacity increases as the time required to perform OPC increases.

In contrast to the conventional OPC method, the writing power determination method according to an embodiment of the present invention, as shown in FIG. 4, advantageously reduces the time required to seek positions where to start reading the written data, thereby achieving efficient writing power detection.

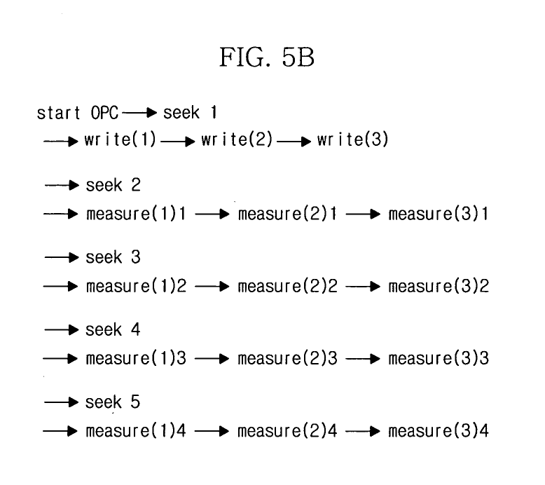

An efficient writing power detection method according to an embodiment of the present invention is now described in comparison with a conventional OPC method with reference to FIGS. 5A and 5B.

Here, let us assume that test data is written three (3) times and each written test data element is read four (4) times in order to reduce the difference between OPC results. In this case, as shown in FIG. 5A, the conventional OPC method performs processes of “seek 1, seek 6, and seek 11” to seek and move to unwritten areas in the PCA 140, that is, a test area of an optical disc 10, as shown, for example, in FIG. 3, and processes of “seek 2-5, seek 7-10, and seek 12-16” to seek and move to test data writing start positions to read the written test data and thus requires a long time for the seek and movement operations.

On the other hand, as shown in FIG. 5B, the writing power detection method according to an embodiment of the present invention performs a process of “seek 1” to seek and move to an unwritten area and processes of “seek 2-5” to seek and move to test data writing start positions, thereby significantly reducing the time required for the seek and movement operations. As a result, when it is necessary to perform OPC a large number of times, the writing power detection method according to the present invention more significantly reduces the required time, thereby reducing manufacturing costs of specific recording media. However, when all the test data elements are not consecutively written (i.e., some of the test data elements alone are consecutively written), the writing power detection method of the present invention may require an additional seek and movement time to sequentially read the separately written test data elements. Also in this case, the present invention reduces the time required for the writing power detection, when compared to the conventional OPC method.

As is apparent from the above description, the present invention provides an optical disc apparatus and a method of determining an optimal writing power of the same, which have a variety of advantages. For example, a more accurate optimal writing power can be detected since the writing power is detected using test data that has been written more than once. It is also possible to significantly reduce the time required to detect the accurate and reliable optimal writing power. In addition, it is possible to significantly reduce the lead-in time of the optical disc. Further, it is possible to reduce the manufacturing costs.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, other recording media, such as DVD, DVD-R, DVD-RW, DVD+RW, DVD-RAM, DVD-ROM, CD, CD-R, CD-RW, CD-ROM and other holographic data storage devices may be utilized, as long as the OPC is implemented in the manner as described with reference to FIG. 2 and FIG. 3. In addition, the test area can be fixed and/or flexible in designated areas of an optical disc. Similarly, the system controller can be implemented as a chipset having firmware, or alternatively, a general or special purposed computer programmed to implement methods as described with reference to FIG. 3. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. An optical disc apparatus comprising:
a light source to emit a laser beam to write/read data to/from an optical disc;
a reader arranged to receive a laser beam reflected from the optical disc and read data written on the optical disc; and
a controller arranged to control the light source to write test data more than once on the optical disc for determining an optimal writing power, to control the reader to read the test data from the optical disc, to measure read quality of the test data, and to detect an optimal writing power based on the measured read quality.

2. The optical disc apparatus according to claim 1, wherein the test data is written more than once on the optical disc, such that test data elements are consecutively written on a specific area of the optical disc without reading the written test data until writing the last test data element is completed.

3. The optical disc apparatus according to claim 2, wherein the test data is read from the optical disc, such that the test data elements are sequentially read, starting from the first written test data element and ending with the last written test data element, after writing the test data is completed.

4. The optical disc apparatus according to claim 3, further comprising a memory to store a variety of data,
wherein the test data is read more than once from the optical disc, and read quality of each of the test data elements is measured and the measured read quality of each of the test data elements is stored in the memory.

5. The optical disc apparatus according to claim 1, wherein the test data is written on the optical disc, while changing writing power applied to the light source.

6. The optical disc apparatus according to claim 1, wherein the optical disc is a write-once optical disc.

7. An optical disc apparatus comprising:
a light source to emit a laser beam to write/read data to/from an optical disc;
a reader arranged to receive a laser beam reflected from the optical disc and read data written on the optical disc; and
a controller arranged to control the light source to write test data more than once on the optical disc, while changing positions where the test data is written for determining an optimal writing power for applying to the light source and thereafter to control the reader to read the test data, to measure read quality of the test data, and to detect an optimal writing power based on the measured read quality.

8. The optical disc apparatus according to claim 7, wherein the test data is written more than once on the optical disc, such that test data elements are consecutively written on a specific area of the optical disc without reading the written test data until writing the last test data element is completed.

9. The optical disc apparatus according to claim 7, wherein the test data is read from the optical disc, such that test data elements are sequentially read, starting from the first written test data element and ending with the last written test data element, after writing the test data is completed.

10. The optical disc apparatus according to claim 7, wherein the optical disc is a write-once optical disc.

11. A method of determining a writing power of an optical disc apparatus to write/read data to/from an optical disc, the method comprising:
writing test data on a specific area of an optical disc more than once to determine an optimal writing power;
reading the written test data more than once and measuring read quality of the test data; and
determining an optimal writing power using the measured read quality.

12. The method according to claim 11, wherein writing the test data more than once comprises consecutively writing test data elements on a specific area of the optical disc without reading the written test data until writing the last test data element is completed.

13. The method according to claim 12, wherein reading the test data comprises sequentially reading the test data elements from the optical disc, starting from the first written test data element and ending with the last written test data element, after writing the test data is completed.

14. The method according to claim 13, wherein the test data elements are sequentially read from the optical disc, and read quality of each of the test data elements is measured and then the measured read quality of each of the test data elements is stored.

15. The method according to claim 11, wherein writing the test data comprises writing the test data on the optical disc, while changing writing power applied to the light source.

16. An apparatus comprising:
an optical pickup to irradiate a laser beam onto an optical disc for recording and reproducing data;
a memory having a designated area to store test data to perform optimum power calibration (OPC);
a controller arranged to control the optical pickup and to access the memory for performing optimum power calibration (OPC),
wherein the controller is configured to:
write test data on the designated area of the optical disc and repeat writing written test data at different segments within the designated area of the optical disc a predetermined number of times;
read written test data at each segment of the designated area of the optical disc sequentially, while measuring the quality of a read signal representing the written test data at each segment within the designated area of the optical disc and storing measured results in the memory; and
determine an optimal writing power based on the measured results and store the optical writing power in the memory for performing optimum power calibration (OPC).

17. The apparatus according to claim 16, wherein the controller is further configured to write test data elements consecutively at different segments within the designated area of the optical disc without reading the written test data until writing a last test data element is completed.

18. The apparatus according to claim 17, wherein the controller is further configured to read written test data elements sequentially from the different segments within the designated area of the optical disc, starting from a first written test data element and ending with the last written test data element, after writing the test data is completed.

19. The apparatus according to claim 17, wherein the controller is further configured to read test data elements sequentially from the different segments within the designated area of the optical disc, to measure the read quality of each of the test data elements and then to store the measured read quality of each of the test data elements in the memory.

20. The apparatus according to claim 16, wherein the controller is further configured to write test data at different segments within the designated area of the optical disc, while changing writing power applied to the light source.
